(19) United States
(12) Patent Application Publication
(10) Pub. No.: US 2003/0179305 A1
(43) Pub. Date: Sep. 25, 2003

(54) Motor vehicle with electronic image transfer system

(76) Inventor: Tim Weis, Bensheim (DE)

Correspondence Address: McGLEW AND TUTTLE, P.C., SCARBOROUGH STATION, SCARBOROUGH, NY, 10510-0827, US

(21) Appl. No.: 10/391,815

(22) Filed: Mar. 18, 2003

(30) Foreign Application Priority Data
Mar. 19, 2002 (DE) 102 12 209.1

(51) Int. Cl. H04N 5/222

(52) U.S. Cl. 348/333.01

(57) ABSTRACT

An image transfer system for motor vehicles with an electronic image acquisition, e.g., a video camera, which encompasses a specific luminance dynamic range (01) between a minimum value and maximum value (Kₘᵢₙ, Kₘₐₓ), an electronic image display unit, e.g., a display, which encompasses a specific luminance dynamic range (02) between a minimum value and a maximum value (Dₘᵢₙ, Dₘₐₓ), and an image processing unit. The processing unit prepares image signals generated by the image acquisition unit for the image display unit in such a way as to image the luminance dynamic range (01) of the image acquisition unit onto the luminance dynamic range (02) of the image display unit. At least one acquisition threshold (Kₛ) and a display threshold (Dₛ) are filed in the image processing unit, enabling a selective contrast spread during image processing.

### FIELD OF THE INVENTION

The invention relates to an image transfer system for motor vehicles with an electronic image acquisition unit, e.g., a video camera, which encompasses a specific luminance dynamic range between a minimum value and maximum value an electronic image display unit, e.g., a display, which encompasses a specific luminance dynamic range between a minimum value and a maximum value, and an image processing unit, in which the image signals generated by the image acquisition unit for the image display unit are prepared in such a way as to image the luminance dynamic range of the image acquisition unit onto the luminance dynamic range of the image display unit.

### BACKGROUND OF THE INVENTION

Generic image transfer systems for motor vehicles are known in the art, and used as parking aids, for example. In these image transfer systems, a certain segment of the environment, for example on the vehicle tail, is recorded with an image acquisition unit, e.g., a video camera, and relayed to an image-processing unit. In the image-processing unit, the image signals are prepared in such a way that the recorded images can be displayed on an image display unit, e. g., a video display in the interior of the vehicle.

One problem in such image transfer systems is that the image acquisition unit and image display unit encompass different luminance dynamic ranges. The video cameras available today can have a luminance dynamic range of up to 60 dB, in special cameras even up to 120 dB. By contrast, the luminance dynamic range that can be displayed with commercially available video displays is generally lower, ranging only from 20 to 30 dB. Since the luminance dynamic ranges of the image acquisition unit and image display unit are imaged one onto the other, this difference in luminance dynamic ranges flattens the contrast when displaying the images. This flattened contrast becomes a problem in particular if spotlights are present in the recorded observation area, e. g., caused by sunlight or headlights. The flattened contrast makes it impossible to discern any more contrasts and details in the images displayed in these cases. Rather, only the spotlights are clearly displayed, while the remaining environment is displayed as a weakly contrasted background.

From WO 99/33684 there is known an electronic image transfer system for motor vehicles. The images recorded by a digital camera are processed in a microprocessor and then displayed for the driver on a display.

### SUMMARY OF THE INVENTION

The primary object of this invention is to provide a motor vehicle with an image transfer system that overcomes the shortcomings of the known prior art.

According to the invention an image transfer system for motor vehicles is provided with an electronic image acquisition unit, e.g., a video camera, which encompasses a specific luminance dynamic range between a minimum value and maximum value an electronic image display unit, e.g., a display, which encompasses a specific luminance dynamic range between a minimum value and a maximum value, and an image processing unit. The image processing unit prepares the image signals generated by the image acquisition unit for the image display unit in such a way as to image the luminance dynamic range of the image acquisition unit onto the luminance dynamic range of the image display unit. At least one acquisition threshold and a display threshold are filed in (provided to) the image processing unit. The value range of the image acquisition unit, which lies between a minimum and another value is imaged onto the value range of the image display unit. The value range of the image display unit lies between a mnimum and some value. The image range of the image acquisition unit, which lies between some value and a maximum is imaged onto the value range of the image display unit, which lies between some value and a maximum.

The invention is based on the underlying idea that the luminance dynamic range recorded by the image acquisition unit is not uniformnly imaged on the luminance dynamic range displayable by the image display unit, but that the luminance dynamic image available in the image display unit is concentrated on the relevant segments of the image data. To this end, an acquisition threshold and display threshold are filed in (provided to) the image-processing unit, dividing the luminance dynamic ranges of the image acquisition unit and image display unit into at least two value ranges each. The lower or upper value ranges of the image acquisition unit and image display unit respectively allocated to each other are here separately imaged onto each other. This makes it possible to spread the contrast of image signals from especially relevant brightness ranges, while flattening the contrast of displayed image signals from other brightness ranges.

As a result, a spectrogram revealing the distribution of brightness values for the acquired image signals is generated in the image-processing unit, wherein image signals caused by spotlights inside the image are detected and imaged with a flattened contrast.

In a preferred embodiment, the threshold for subdividing the luminance dynamic range of the image display unit corresponds exactly to the maximum value for the luminance dynamic range. This makes it possible to show all image signals whose brightness values exceed the threshold in the luminance dynamic range of the image acquisition unit on the display with maximum brightness. This means that image signals with a brightness value exceeding the threshold are shown relative to each other without contrast on the display with the same brightness. The entire contrast range of the image display unit is therefore available for image signals, whose brightness value lies under the threshold in the luminance dynamic range of the image acquisition unit.

In order to variably adjust the image display system to different boundary conditions, it is particularly advantageous that it be possible to variably change the acquisition threshold or display threshold, especially in a program-controlled manner. For example, it is conceivable that the two thresholds are changed as a function of the ambient brightness, since the optimal spreading or flattening of the contrast can also depend heavily on the ambient lighting. Darkness requires a different contrast distribution than daylight. It is also conceivable to vary the contrast distribution as a function of vehicle speed, since for example the image signals that are especially relevant are different when parking compared to, for example, driving fast on the highway.

In addition, at least two separate display ranges can be defined for the image display unit. The acquisition threshold and/or display threshold can then be individually set for each display range. This makes it possible, for example, to modify the contrast of the displayed image foreground displayed in the lower area of a display in another way than the contrast of the displayed image background, which is shown in the upper area of a display.

Depending on the respective application, several thresholds can also be stipulated in the two luminance dynamic ranges of the image acquisition unit and image display unit, wherein the value ranges defined as a result are then each imaged onto each other.

The mode of operation of the image transfer system in a motor vehicle according to the invention is shown diagrammatically in the drawings, and will be described below based on examples.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a diagram showing the image of the luminance dynamic ranges in a conventional image transfer system;

FIG. 2 is a diagram showing the image of the luminance dynamic ranges in a first embodiment of an image transfer system according to the invention;

FIG. 3 is a diagram showing the image of the luminance dynamic ranges in a second embodiment of an image transfer system according to the invention;

FIG. 4 is a diagram showing the image of the luminance dynamic ranges in a third embodiment of an image transfer system according to the invention.

### DESCRIPTION OF THE PREFERRED EMBODIMENT

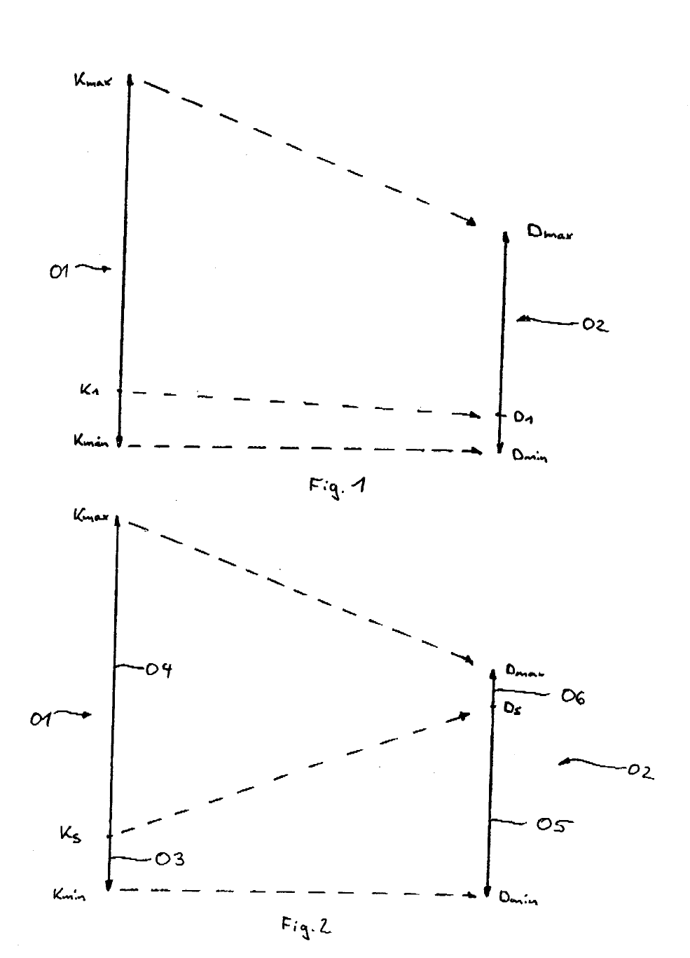

Referring to the drawings in particular, the image of the luminance dynamic range 01 of an image acquisition unit, e.g., a video camera, on the luminance dynamic range 02 of an image display unit, e.g., a video display, shown in FIG. 1 reflects known prior art. The entire luminance dynamic range 01 from Kₘᵢₙ to K_{max,} which comprises 60 dB, for example, is linearly imaged onto the luminance dynamic range 02 from Dₘᵢₙ, to Dₘₐₓ which measures only 30 dB, for example. As is evident from the above, the smaller luminance dynamic range 02 of the image display unit causes the contrast to flatten. If the maximum value in the luminance dynamic range 01 of the image acquisition unit corresponds to a spotlight, e.g., a headlight, this flattened contrast becomes even more acute. This is because, if all relevant image signals were to have a brightness value lying between Kₘᵢₙ and K₁ these relevant image signals would be imaged on a very small segment of the luminance dynamic range on the display between Dₘᵢₙ and D₁. The spotlight with a brightness value of Kₘₐₓ, would be shown on the display with Dₘₐₓ, which would result in only the spotlight being clearly discernible on the image shown on the display, while the surrounding areas relevant for providing information to the driver, which lie in proximity of the vehicle tail and are only slightly illuminated, would be shown with very little contrast, specifically corresponding to the brightness range between Dₘᵢₙ and D₁.

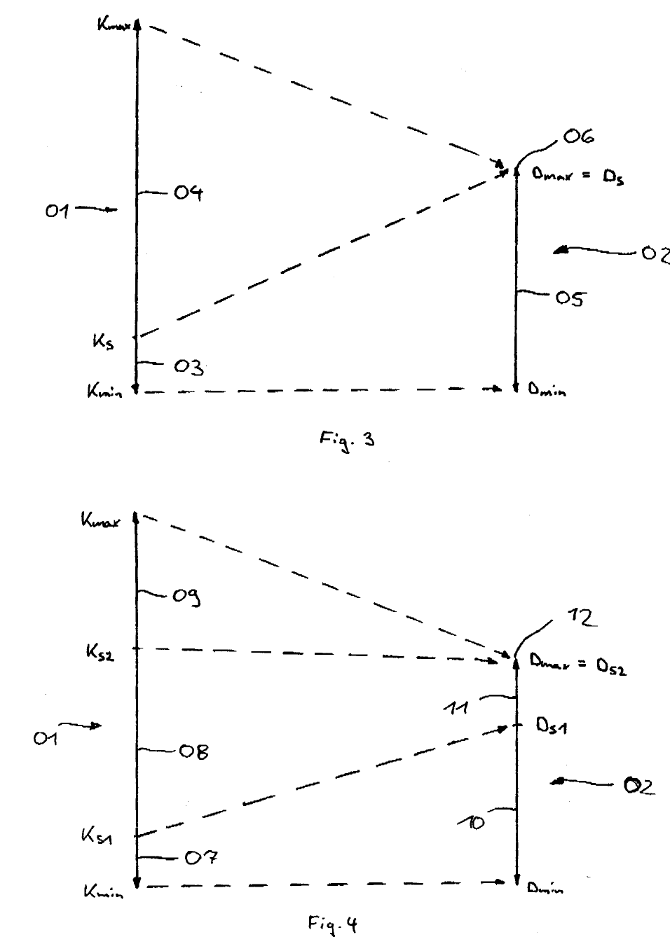

This problem is resolved by an image transfer system that images the luminance dynamic ranges 01 and 02 onto each other in a manner depicted in FIG. 2, FIG. 3 or FIG. 4.

In the embodiment shown in FIG. 2, the luminance dynamic range 01 of the image acquisition unit is divided into value ranges 03 and 04 by the threshold Kₛ. Correspondingly, the luminance dynamic range 02 of the image display unit is divided into the value ranges 05 and 06 by the threshold Dₛ. While preparing the image signals in the image-processing unit, processing takes place in such a way as to linearly image the value range 03 onto the value range 05. This makes it possible to spread the contrast of the image signals, whose brightness lies in the value range 03. By contrast, the value range 04 is imaged onto the relatively small value range 06, so that image signals whose brightness lies in the value range 04 are shown on the display with a weakened contrast.

All of this makes it possible to display image data having relevant brightness values lying in the value range 03, spreading the contrast, while image data with brightness values that are not as relevant are shown with a weaker contrast.

In the embodiment shown in FIG. 3, threshold Dₛ corresponds exactly to the maximum brightness value Dₘₐₓ, that can be shown on the display, so that the value range 06 shrinks to one value. This only means that all image signals whose brightness lies above the threshold Kₛ are displayed with a brightness corresponding to the value Dₘₐₓ, All image signals with a lower brightness, i. e., whose brightness lies in the value range 03, are represented with a spread contrast, while the entire luminance dynamic range of the display is available for the corresponding value range 05.

In the embodiment shown in FIG. 4, two thresholds Kₛ₁, and Kₛ₂ or Dₛ₁ and Dₛ₂ each define three value ranges 07, 08 and 09 or 10, 11 and 12 in the luminance dynamic ranges 01 and 02. The value range 11 here only encompasses precisely the maximum value Dₘₐₓ. By taking this measure, various brightness ranges can be displayed with a varying contrast spread.

While specific embodiments of the invention have been shown and described in detail to illustrate the application of the principles of the invention, it will be understood that the invention may be embodied otherwise without departing from such principles.

What is claimed is:

1. An image transfer system for motor vehicles, the system comprising:
an electronic image acquisition unit which encompasses a specific luminance dynamic range between a minimum value and maximum value;
an electronic image display unit which encompasses a specific luminance dynamic range between a minimum value and a maximum value; and
an image processing unit, in which the image signals generated by the image acquisition unit for the image display unit are prepared in such a way as to image the luminance dynamic range of the image acquisition unit onto the luminance dynamic range of the image display unit and with at least one acquisition threshold and a display threshold provided in the image processing unit, wherein a value range of the image acquisition unit, which lies between the minimum luminance and the acquisition threshold is imaged onto the value range of the image display unit, which lies between the minimum and the display threshold, and wherein the image range of the image acquisition unit, which lies between the acquisition threshold and the maximum is imaged onto the value range of the image display unit, which lies between the display threshold and the maximum.

2. The image transfer system according to claim 1, wherein the value ranges defined by the acquisition threshold are each linearly imaged onto the value ranges defined by the display threshold.

3. The image transfer system according to claim 1, wherein the value of the display threshold corresponds roughly to the value of the display maximum.

4. The image transfer system according to claim 1, wherein the acquisition threshold and/or the display threshold can be varied as a function of specific boundary conditions including one of the brightness in the environment and the vehicle speed, in a program-controlled manner.

5. The image transfer system according to claim l,wherein at least two separate display ranges are defined for the image display unit, wherein the acquisition threshold and/or the display threshold is individually defined for each display range.

6. The image transfer system according to claim 1, wherein several acquisition thresholds are provided, with each acquisition threshold being allocated one display threshold.

7. The image transfer system according to claim 1, wherein the luminance dynamic range of the image acquisition unit encompasses a value range of 40 to 120 dB.

8. The image transfer system according to claim 1, wherein the luminance dynamic range of the image display unit encompasses a value range of 10 to 30 dB.

9. The image transfer system according to claim 1, wherein the image acquisition unit is arranged in such a way that the images shown on the image display unit is part of a parking aid system for the driver.

10. The image transfer system according to claim 1, wherein the image acquisition unit is arranged in such a way that the images shown on the image display unit serve as a rear view mirror replacement for the driver.

11. The image transfer system according to claim 1 to wherein the electronic image acquisition unit is a video camera.

12. A method of processing images for an image transfer system for motor vehicles, the method comprising:
generating image signals with an electronic image acquisition unit which encompasses a specific luminance dynamic range between an acquisition minimum value and an acquisition maximum value;
displaying an electronic image with a display unit which encompasses a specific luminance dynamic range between a display minimum value and a display maximum value; and
preparing the image signals generated by the image acquisition unit for the image display unit so as to image the luminance dynamic range of the image acquisition unit onto the luminance dynamic range of the image display unit based on at least one acquisition threshold and at least one display threshold wherein an image signal value range of the image acquisition unit, which lies between the minimum acquisition luminance and the acquisition threshold is imaged onto the value range of the image display unit, which lies between the minimum display luminance and the display threshold, and wherein the image signal value range of the image acquisition unit, which lies between the acquisition threshold and the maximum acquisition luminance is imaged onto the value range of the image display unit, which lies between the display threshold and the maximum display luminance.

13. The method according to claim 12, wherein the value ranges defined by the acquisition threshold are each linearly imaged onto the value ranges defined by the display threshold.

14. The method according to claim 12, wherein the value of the display threshold corresponds roughly to the value of the display maximum.

15. The method according to claim 12, wherein the acquisition threshold and/or the display threshold can be varied as a function of specific boundary conditions including one of the brightness in the environment and the vehicle speed, in a program-controlled manner.

16. The method according to claim 1 2,wherein at least two separate display ranges are defined for the image display unit, wherein the acquisition threshold and/or the display threshold is individually defined for each display range.

17. The method according to claim 12, wherein several acquisition thresholds are provided, with each acquisition threshold being allocated one display threshold.
